(19) United States
(12) Patent Application Publication
(10) Pub. No.: US 2013/0164615 A1
(43) Pub. Date: Jun. 27, 2013

(54) CONDUCTIVE POLYMER-COATED, SHAPED SULFUR-NANOCOMPOSITE CATHODES FOR RECHARGEABLE LITHIUM-SULFUR BATTERIES AND METHODS OF MAKING THE SAME

(71) Applicants: Arumugam Manthiram, Austin, TX (US); Youngzhu Fu, Austin, TX (US)

(72) Inventors: Arumugam Manthiram, Austin, TX (US); Youngzhu Fu, Austin, TX (US)

(21) Appl. No.: 13/335,536

(22) Filed: Dec. 22, 2011

(51) Int. Cl. H01M 4/62; H01B 1/12; B05D 5/12; B82Y 40/00; B82Y 30/00

(52) U.S. Cl. 429/212; 252/500; 427/77; 977/773; 977/890

(57) ABSTRACT

The present disclosure relates to a nanocomposite comprising shaped sulfur and a polymer layer coating the shaped sulfur. An alternative embodiment of the disclosure provides a method of synthesizing a nanocomposite. This method comprises forming a shaped sulfur. This may include preparing an aqueous solution of a sulfur-based ion and a micelle-forming agent, and adding a nucleating agent. The method further includes coating the shaped sulfur with a polymer layer. Another embodiment of the disclosure provides a cathode comprising nanocomposites of the present disclosure, and batteries incorporating such cathodes.

### TECHNICAL FIELD

The current disclosure relates to a polymer-coated, shaped sulfur-nanocomposite usable as a cathode in batteries, particularly lithium-sulfur secondary (rechargeable) batteries and to methods of making such a nanocomposite. The disclosure also relates to cathodes and batteries containing such nanocomposites.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode or cathode and the negative electrode or anode, an insulator separating the electrodes so the battery does not short out, and an electrolyte that chemically connects the electrodes.

In operation the secondary battery exchanges chemical energy and electrical energy. During discharge of the battery, electrons, which have a negative charge, leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge leaves the anode and enters the electrolyte and a positive ion also leaves the electrolyte and enters the cathode. In order for this ion movement to work, typically the same type of ion leaves the anode and joins the cathode. Additionally, the electrolyte typically also contains this same type of ion. In order to recharge the battery, the same process happens in reverse. By supplying energy to the cell, electrons are induced to leave the cathode and join the anode. At the same time a positive ion, such as Li⁺, leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries it forms a coating on the metal backing.

Unless additional materials are specified, batteries as described herein include systems that are merely be electrochemical cells as well as more complex systems.

Several important criteria for rechargeable batteries include energy density, power density, rate capability, cycle life, cost, and safety. The current lithium-ion battery technology based on insertion compound cathodes and anodes is limited in energy density. This technology also suffers from safety concerns arising from the chemical instability of oxide cathodes under conditions of overcharge and frequently requires the use of expensive transition metals. Accordingly, there is immense interest to develop alternate cathode materials for lithium-ion batteries. Sulfur has been considered as one such alternative cathode material.

### Lithium-Sulfur Batteries

Lithium-sulfur (Li—S) batteries are a particular type of rechargeable battery. Unlike most rechargeable batteries in which the ion actually moves into and out of a crystal lattice, the ion on lithium sulfur batteries reacts with lithium in the anode and with sulfur in the cathode even in the absence of a precise crystal structure. In most Li—S batteries the anode is lithium metal (Li or) Li⁰. In operation lithium leaves the metal as lithium ions (Li⁺) and enters the electrolyte when the battery is discharging. When the battery is recharged, lithium ions (Li⁺) leave the electrolyte and plate out on the lithium metal anode as lithium metal (Li). At the cathode, during discharge, particles of elemental sulfur (S) react with the lithium ion (Li⁺) in the electrolyte to form Li₂S. When the battery is recharged, lithium ions (Li⁺) leave the cathode, allowing to revert to elemental sulfur (S).

Sulfur is an attractive cathode candidate as compared to traditional lithium-ion battery cathodes because it offers an order of magnitude higher theoretical capacity (1675 mAh g⁻¹) than the currently employed cathodes (<200 mAh g⁻¹) and operates at a safer voltage range (1.5-2.5 V). In addition, sulfur is inexpensive and environmentally benign.

However, the major problem with a sulfur cathode is its poor cycle life. The discharge of sulfur cathodes involves the formation of intermediate polysulfide ions, which dissolve easily in the electrolyte during the charge-discharge process and result in an irreversible loss of active material during cycling. The higher-order polysulfides (Li₂Sₙ, 4≦n≦8) produced during the initial stage of the discharge process are soluble in the electrolyte and move toward the lithium metal anode, where they are reduced to lower-order polysulfides. Moreover, solubility of these high-order polysulfides in the liquid electrolytes and nucleation of the insoluble low-order sulfides (i.e., Li₂S₂ and Li₂S) result in poor capacity retention and low Coulombic efficiency. In addition, shuttling of these high-order polysulfides between the cathode and anode during charging, which involves parasitic reactions with the lithium anode and re-oxidation at the cathode, is another challenge. This process results in irreversible capacity loss and causes the build-up of a thick irreversible Li₂S barrier on the electrodes during prolonged cycling, which is electrochemically inaccessible. Overall, the operation of Li—S cells is so dynamic that novel electrodes with optimized compositions and structure are needed to maintain the high capacity of sulfur and overcome the challenges associated with the solubility and shuttling of polysulfides.

Moreover, sulfur is an insulator with a resistivity of 5×10⁻³⁰ S cm⁻¹ at 25° C., resulting in a poor electrochemical utilization of the active material and poor rate capacity. Although the addition of conductive carbon to the sulfur material could improve the overall electrode conductivity, the core of the sulfur particles, which have little or no contact with conductive carbon, will still be highly resistive.

Extensive research has been focused recently on developing composite materials consisting of sulfur and carbon or conductive polymers to improve the electrical conductivity and utilization of sulfur within the electrodes. The methods include mixing sulfur and carbon by grinding, synthesizing composite materials containing sulfur and carbon with different structure and morphology (e.g., mesoporous carbon, multi-wall carbon nanotubes, and graphenes) or sulfur and conductive polymers, and developing core-shell structured composites. Although these materials show improvements in electrochemical performance due to a better confinement of sulfur within the electrode, new synthesis strategies are needed for making better confinement of sulfur with controlled morphology.

### SUMMARY

Accordingly, certain embodiments of the disclosure present a nanocomposite comprising shaped sulfur and a polymer layer coating the shaped sulfur.

An alternative embodiment of the disclosure provides a method of synthesizing a nanocomposite. This method comprises forming a shaped sulfur. This may include preparing an aqueous solution of a sulfur-based ion and a micelle-forming agent, and adding a nucleating agent configured to cause sulfur from the sulfur-based ions to nucleate into shaped sulfur particles within micelles formed by the micelle-forming agent. The method further includes coating the shaped sulfur with a polymer layer.

Another embodiment of the disclosure provides a cathode comprising a nanocomposite comprising shaped sulfur and a polymer layer coating the shaped sulfur.

One embodiment of the disclosure provides a battery. The battery comprises a cathode. The cathode may include a nanocomposite comprising shaped sulfur and a polymer layer coating the shaped sulfur. The battery also includes an anode and an electrolyte.

The following abbreviations are commonly used throughout the specification:
Li⁺—lithium ion
Li or Li⁰—elemental or metallic lithium or lithium metal p0 S—sulfur
Li—S—lithium-sulfur
Li₂S—lithium sulfide
S—C—sulfur-carbon
Na₂S₂O₃—sodium thiosulfate
K₂S₂O₃—potassium thiosulfate
MₓS₂O₃—metal thiosulfate
H⁺—hydrogen ion
HCl—hydrochloric acid
C₃H₈O—isopropyl alcohol
DeTAB—decyltrimethylammonium bromide
PPy—polypyrrole
S-PPy—sulfur-polypyrrole
DI—deionized
PVdF—polyvinylidene fluoride
NMP—N-methylpyrrolidinone
DME—1,2-dimethoxyethane
DOL—1,3-dioxolane
TGA—thermogravimetric analysis
SEM—scanning electron microscope
XRD—X-ray diffraction
TEM—transmission electron microscope
EDS—energy dispersive spectrometer
CV—cyclic voltammetry
EIS—electrochemical impedance spectroscopy
XPS—X-ray photoelectron spectroscopy

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure. The current specification contains color drawings. Copies of these drawings may be obtained from the USPTO.

FIG. 1A provides an example of a synthesis process for forming a polymer-coated, shaped sulfur-nanocomposite according to the present disclosure.

FIG. 1B provides an SEM image of bipyramidal sulfur particles; the bar is 10 μm. The insert is a magnified SEM image of the sulfur particles; the bar is 1 μm.

FIG. 1C provides an SEM image of a polymer-coated, shaped sulfur-nanocomposite; the bar is 1 μm.

FIG. 1D provides XRD patterns of sulfur and a polymer-coated, shaped sulfur-nanocomposite.

FIG. 2 provides TGA of sulfur, and multiple polymer-coated, shaped sulfur-nanocomposites.

FIG. 3 provides XPS spectrum of a polymer-coated, shaped sulfur-nanocomposite.

FIGS. 4A and 4B provide SEM images of a polymer-coated, shaped sulfur-nanocomposite; the bar is 1 μm. FIG. 4A depicts one central polymer-coated, shaped sulfur-nanocomposite. FIG. 4B depicts multiple nanocomposites.

FIG. 5A provides CV data of a polymer-coated, shaped sulfur-nanocomposite at a sweep rate of 0.2 mV/s.

FIG. 5B provides voltage vs. specific capacity of sulfur profiles of a polymer-coated, shaped sulfur-nanocomposite cathode at 2.8-1.5 V and C/5 rate.

FIG. 6A provides cyclability data and Coulombic efficiency of a polymer-coated, shaped sulfur-nanocomposite cathode at C/5 rate for cycles 0-50.

FIG. 6B provides EIS data of a polymer-coated, shaped sulfur-nanocomposite cathode before and after 50 cycles. The large graph represents the whole frequency range of 1 MHz to 0.1 Hz and the insert presents the high frequency range.

FIG. 7A provides voltage vs. specific capacity of sulfur for a polymer-coated, shaped sulfur-nanocomposite at rates of C/20, C/10, C/5, and 1C.

FIG. 7B provides cyclability data for a polymer-coated, shaped sulfur-nanocomposite at rates of C/20, C/10, C/5, and 1C.

FIG. 8 provides cyclability data for sulfur at rates of C/20, C/10, C/5, and 1C.

FIG. 9 provides cyclability data for an alternative polymer-coated, shaped sulfur-nanocomposite with 90 weight % sulfur at rates of C/20, C/10, and C/5.

### DETAILED DESCRIPTION

The current disclosure relates to a polymer-coated, shaped sulfur-nanocomposite usable as a cathode in batteries, particularly lithium-sulfur secondary (rechargeable) batteries and to methods of making such a nanocomposite. The disclosure also includes cathodes and batteries containing such nanocomposites.

### Method of Forming Polymer-Coated, Shaped Sulfur-Nanocomposite

According to one embodiment, the disclosure provides a two step-method for forming a polymer-coated, shaped sulfur-nanocomposite. In the initial step, a shaped sulfur is formed. Then, in a second step, the shaped sulfur is coated with a nano-sized polymer layer.

In some embodiments, the initial step may comprise forming an aqueous solution including a micelle-forming agent and sulfur-based ions from a sulfur source. The sulfur source may be a metal thiosulfate (MₓS₂O₃) such as sodium thiosulfate (Na₂S₂O₃) or potassium thiosulfate (K₂S₂O₃), or any other compounds with a thiosulfate ion or other sulfur-based ions. In some embodiments, the micelle-forming agent may be cationic, anionic, nonionic, or amphoteric surfactants, such as quaternary ammonium salts (e.g., decyltrimethylammonium bromide (DeTAB)), or any other compound with a hydrophilic head and a hydrophobic tail able to from a micelle.

The initial step may further comprise adding a nucleating agent to cause sulfur from the sulfur source to nucleate into individual shaped sulfur particles. The nucleating agent may be hydrochloric acid, or any other H⁺ source able to facilitate the precipitation of sulfur by providing H⁺ either directly or indirectly to the sulfur-based ions. In some embodiments, this precipitation will occur within the micelles formed by the micelle-forming agent. In other embodiments, the nucleated sulfur will migrate from the aqueous solution to the micelles. In some embodiments, the individual shaped sulfur particles may be a uniform bipyramidal shape or spherical shape. In some embodiments, the environment in the micelles may be dynamic, such that the micelles will continue to adjust their shape to accommodate the growth of the individual shaped sulfur particles into their most stable form. This may be orthorhombic crystals of sulfur.

In some embodiments, the initial step may occur at any temperature below 120° C. For example, the initial step may occur at room temperature. In some embodiments, the sulfur source, micelle-forming agent, and the nucleating agent may be added at the same time, or in any other order. In some embodiments, the initial step may proceed with stirring. In some embodiments, the initial step may proceed for about 3 hours or longer. In some embodiments, the duration may be modified by shifting the reagent concentrations. For instance, use of a higher temperature and higher concentration of thiosulfate or acid may result in larger particle sizes and different sulfur shapes.

The second step comprises coating the shaped sulfur with a nano-sized polymer layer. In some embodiments, a monomer of a polymer is added to the reaction mixture containing the shaped sulfur. The monomer may be the precursor to any of polypyrrole, polyaniline, polythiophene, or their derivatives. In alternative embodiments, any electrically conductive polymer may be used. The monomers may begin to accumulate within the micelles. The polymerizing reagent may form polypyrrole or another polymer form available monomers. The polymerizing reagent may be an oxidative compound containing peroxydisulfate or iron (III), such as ammonium peroxydisulfate or iron (III) chloride. The cationic surfactant may include a micelle forming agent, such as DeTAB. The surfactant concentration may be 0.05 M for formation of optimal polymer nanospheres. Higher concentrations may result in smaller polypyrrole nanospheres. In some embodiments, these nanospheres may be approximately 100 nm. In some embodiments, the nanospheres may agglomerate to build a nanolayer on the surface of the sulfur particles. In some embodiments, this may be due to common hydrophobic features, or by the contracting effect of the micelles, or any combination of the two. In some embodiments, the layer of nanospheres may be approximately 100 nm thick. In some embodiments, a coating may be formed upon the shaped sulfur of a single layer of nanospheres.

In some embodiments, the reaction mixture is cooled to between 0 and 5° C. A higher temperature may result in greater polymer particle size, while a lower temperature may slow the polymerization reaction. In some embodiments, cooling may be done in an ice bath. In some embodiments, the second step proceeds for about 4 h. The aqueous reaction mixture may then be filtered, rinsed, and dried. In some embodiments, the nanocomposite filtered out may be washed with water. The drying may occur at 50° C. for 6 hours in some embodiments. In some embodiments, substantially all of the water may be removed from the polymer-coated, shaped sulfur-nanocomposite during washing and drying. In particular, sufficient water may be removed to allow safe use of the sulfur-carbon composite with a Li anode, which may react with water, causing damage to the battery or even an explosion if too much residual water is present.

This method provides several improvements over other conventional methods used to create a carbon and sulfur based cathode. For example, the synthesis may take place in an aqueous solution. This allows for the use of less toxic or less caustic reagents. This also creates a synthesis pathway that is easier to achieve and easier to scale up. In addition, the nanocomposite is pure, with a majority of undesired components being removed from the sulfur-carbon composite during the synthesis process. Purity of the compound may be assessed, for example, by X-ray diffraction, in which any impurities show up as additional peaks. Further, the synthesis process of the present disclosure does not require a subsequent heat treatment or purification process. This decreases time and energy requirements over other conventional methods, allowing for a lower cost method for creation of sulfur-based battery materials.

### Polymer-Coated, Shaped S-Nanocomposites

According to another embodiment, polymer-coated, shaped S-nanocomposite is disclosed. This nanocomposite may be used in a cathode as the active material. Sulfur at an interface with the polymer may be chemically bonded to it, while sulfur located elsewhere is not bonded to the polymer. Alternatively, the sulfur and polymer, particularly near the interface may be physically attached, but not chemically bonded to one another, for example by Van der Waal's forces. The polymer-coated, shaped S-nanocomposite may be formed by following the method described above.

In some embodiments, the shaped sulfur may be generally uniformly shaped, for example, a bipyramidal shape. This may be Fddd orthorhombic sulfur. The shaped sulfur may be on the order of micrometers, or they may be more particularly between 1 and 15 micrometers in length and between 0.1 and 10 micrometers in width. The shaped sulfur may be a substantial portion of the nanocomposite by weight. In some embodiments, this may be up to about 90%, but may be much less, including about 63% sulfur by weight. In a particular embodiment, the shaped sulfur may be between 60-90 wt % of the nanocomposite. If lower amounts of sulfur are present, there may be an overabundance of free polymer not associated with the surface of the shaped sulfur particles.

In some embodiments, the shaped sulfur may have a generally uniform layer of polymer coating the surface thereof. This may be generally uniform in content, shape, or thickness. In some embodiments, this may be on the order of 100s of nanometers, or more particularly, may be about 100 nm thick. In one embodiment, the polymer coating may be between 10 and 500 nm thick. The polymer coating may comprise a plurality of nanospheres of polymer. Alternatively, the polymer coating may be of nanoscale thickness, but have an amorphous structure. These nanospheres may bind to each other. This may be by chemical bonds at the interface between nanospheres, or may be by a physical attachment without a chemical bond, for example by Van der Waal's forces. In other embodiments, the nanospheres may be distinct and not in contact with each other. This may allow a solution, for example an electrolyte, to pass between the nanospheres. In other embodiments, it may be any combination of chemically bound, physically bound, or distinct nanospheres.

The polymer coating may be electrically conductive, and facilitate the use of sulfur as an active material in a battery. The polymer coating may conduct electrons. In some embodiments, the polymer coating may additionally inhibit the dissolution of polysulfides away from the nanocomposite. The polymer coating may further provide a high amount of contact between the electrically conductive polymer and the shaped sulfur.

Polymer-coated, shaped sulfur-nanocomposites of the present disclosure may provide improvements over prior art materials. Nanocomposites of the present invention may have a uniform shape and have a uniform coating. In addition, the polymer coating acts as a conductive matrix for electron transport. This may improve use as an active material in a battery. In addition, the polymer coating of the nanocomposites of the present disclosure may resist the leeching of sulfur from the active material.

### Cathodes and Batteries

The disclosure also includes cathodes made using a polymer-coated, shaped sulfur-nanocomposite as described above as the active material. Such cathodes may include a metal or other conductive backing and a coating containing the active material. The coating may be formed by applying a slurry to the metal backing The slurry and resulting coating may contain particles of the active material. The cathode may contain only one type of active material, or it may contain multiple types of active materials, including additional active materials different from those described above. The coating may further include conductive agents, such as carbon. Furthermore, the coating may contain binders, such as polymeric binders, to facilitate adherence of the coating to the metal backing or to facilitate formation of the coating upon drying of the slurry. In some embodiments the cathode may be in the form of metal foil with a coating. In some embodiments, a slurry may contain a sulfur-carbon composite, carbon black, and a PVdF binder in an NMP solution. This slurry may be tape-casted onto a sheet of aluminum foil and dried in a convection oven at 50° C. for 24 hours. In some embodiments, this may produce an electrode about 30 μm thick with a sulfur content of about between 38 and 54 weight %.

In another embodiment, the disclosure relates to a battery containing a cathode including an active material as described above. The cathode may be of a type described above. The battery may further contain an anode and an electrolyte to complete the basic components of an electrochemical cell. The anode and electrolyte may be of any sort able to form a functional rechargeable battery with the selected cathode material. In one embodiment, the anode may be a lithium metal (Li or Li⁰ anode). The battery may further contain contacts, a casing, or wiring. In the case of more sophisticated batteries it may contain more complex components, such as safety devices to prevent hazards if the battery overheats, ruptures, or short circuits. Particularly complex batteries may also contain electronics, storage media, processors, software encoded on computer readable media, and other complex regulatory components.

Batteries may be in traditional forms, such as coin cells or jelly rolls, or in more complex forms such as prismatic cells. Batteries may contain more than one electrochemical cell and may contain components to connect or regulate these multiple electrochemical cells. polymer-coated, shaped sulfur-nanocomposites of the present disclosure may be adapted to any standard manufacturing processes or battery configurations.

Batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

Batteries using a polymer-coated, shaped S-nanocomposite may enjoy benefits over prior art batteries. For example, the nanocomposite may decrease the charge transfer resistance and help maintain the integrity of an electrode structure during cycling. Additionally, the polymer coating surrounding the shaped sulfur may play a protective role to keep the soluble polysulfides within the electrode structure, avoiding the unwanted shuttle effect during charging. Batteries of the present disclosure also offer capacities of >600 mAh/g after 50 cycles at C/5 rate and maintain 90% efficiency. Such batteries also offer much higher rate capability (1C) compared to traditional Li—S batteries.

Batteries of the present disclosure may provide improvements over prior art batteries. For example, as described above, the synthesis process may be more economical and require less-caustic reagents. In addition, the ability of the nanocomposite to inhibit the dissolving of polysulfides into the electrolyte may provide excellent cycle life, high efficiency, and high utilization of sulfur within the electrodes. The nanocomposites of the present disclosure may provide capacities of greater than 600 mAh/g even after 50 cycles at a C/5 rate and maintain 90% Coulombic efficiency. Additionally, nanocomposites of the present disclosure offer much higher rate capabilities, including 1C, over pure sulfur electrodes.

### EXAMPLES

The following examples are provided to further illustrate specific embodiments of the disclosure. They are not intended to disclose or describe each and every aspect of the disclosure in complete detail and should be not be so interpreted.

### Example 1

### Synthesis of Polymer-Coated, Shaped Sulfur-Nanocomposite

The polymer coated, shaped sulfur-nanocomposite of Example 1 was also used in Examples 2-6 herein.

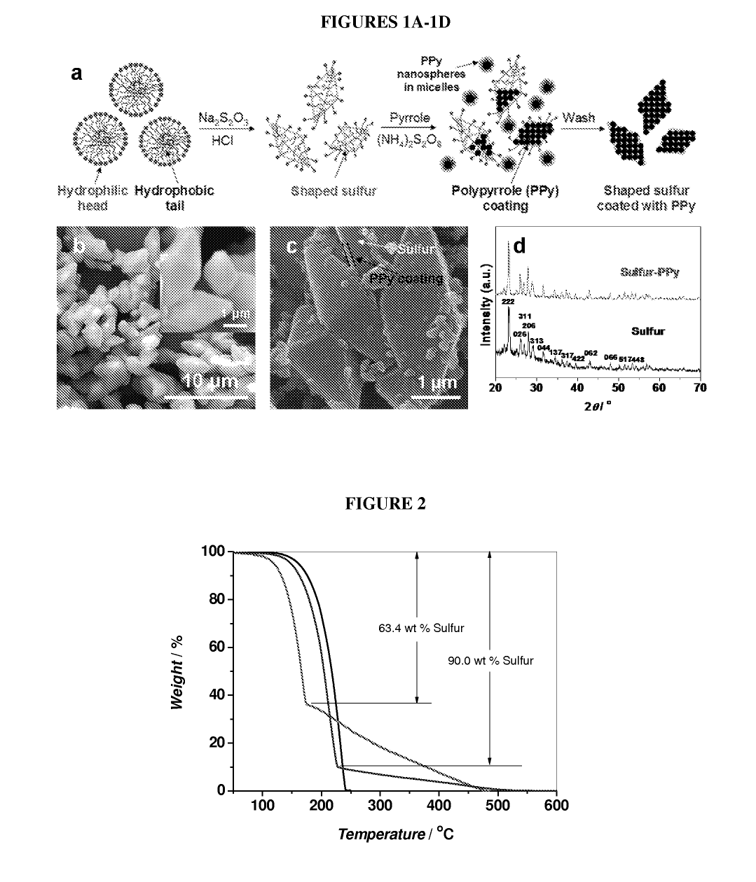

FIG. 1A provides an illustration of one embodiment of a synthesis method for a polymer-coated shaped sulfur nanocomposite. In a typical reaction, sodium thiosulfate pentahydrate (4.963 g, 20 mmol) was dissolved in decyltrimethylammonium bromide (DeTAB) aqueous solution (0.05 M,160 mL) with magnetic stirring. DeTAB consists of a hydrophilic head (trimethylammonium bromide) and a long hydrophobic tail (C₁₂ hydrocarbon chain). An amount of concentrated hydrochloric acid (4 mL) was then added dropwise. DeTAB can form micelles with microsized/nanosized nonpolar environments in water, assisting the formation of individual sulfur particles from the reaction of sodium thiosulfate with dilute hydrochloric acid. The reaction proceeded at room temperature for 3 h and a yellow sulfur colloidal solution was obtained. The obtained sulfur colloidal solution contained microsized sulfur particles with a uniform bipyramidal shape. An appropriate amount of pyrrole was then added while the reaction mixture was cooled to 0-5° C. in an ice bath, followed by an addition of ammonium peroxydisulfate (1.1 equiv mole of pyrrole). The pyrrole formed ultrafine polypyrrole (PPy) nanospheres (˜100 nm) within the DeTAB micelles by the oxidation polymerization reaction under the surfactant concentration (0.05 M). At the same time, the PPy nanospheres agglomerate to build a nanolayer on the surface of the sulfur particles due to their common hydrophobic features with aid of the contracting effect of DeTAB micelles. The reaction proceeded at 0-5° C. for 4 h, and the color of the reaction solution slowly turned black. The product was filtered, rinsed thoroughly with de-ionized water, and dried in an air oven at 50° C. overnight to obtain a black powder. The obtained sulfur particles were coated with a PPy layer consisting of stacked PPy nanospheres.

### Example 2

### Characterization of Polymer-Coated, Shaped Sulfur-Nanocomposite

A polymer-coated, shaped sulfur-nanocomposite of Example 1 was characterized using a scanning electron microscope (SEM), X-ray diffraction (XRD), thermogravimetric analysis (TGA), and X-ray photoelectron spectroscopy (XPS).

Morphological and particle size characterizations were carried out with a JEOL JSM-5610 SEM. The XRD data were collected on a Philips X-ray diffractometer equipped with CuKα radiation in steps of 0.04°. TGA data were collected with a Perkin Elmer Series 7 Thermal Analysis System under flowing air from room temperature to 600° C. at a heating rate of 5° C./min to assess the sulfur content in the S-PPy composites. XPS data were collected at room temperature with a Kratos Analytical spectrometer and monochromatic Al Kα (1486.6 eV) X-ray source to assess the chemical state of C, N, and S on the surface of S-PPy composites.

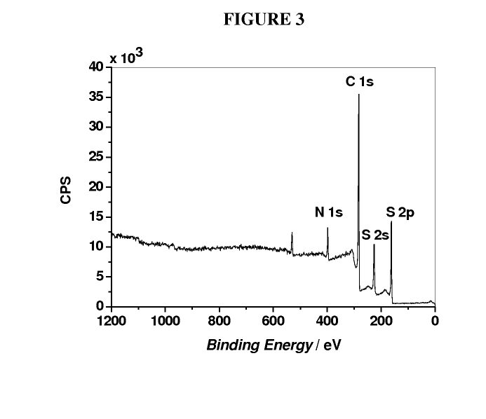

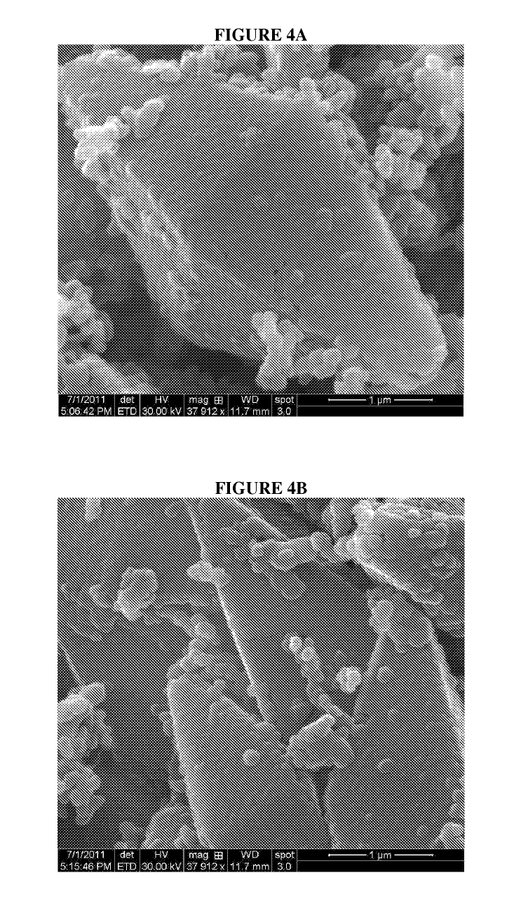

FIG. 1B provides a SEM image of bipyramidal sulfur particles, with the insert showing the uniformity of the shapes. FIG. 1C provides a SEM image of the nanocomposite synthesized in Example, clearly showing sulfur particles coated with a PPy layer consisting of stacked PPy nanospheres. FIG. 1D provides an XRD analysis of pure sulfur and the nanocomposite of Example 1. The positions and intensities of the reflections match well with the literature values for Fddd orthorhombic sulfur. The calculated lattice constants are a=10.4306 Å, b=12.8420 Å, and c=24.3662 Å. As shown in FIG. 2, TGA of the nanocomposite of Example 1 as well as elemental sulfur reveals that S-PPy composites containing up to 90 wt. % sulfur can be synthesized by this approach. As shown in FIG. 3, XPS study confirms the N 1s and C 1s peaks of polypyrrole and S 2s and S 2p peaks of sulfur within the synthesized materials. FIGS. 4A and 4B provide additional SEM images of the nanocomposite of Example 1, clearly showing the stacked PPy nanospheres creating a coating upon the sulfur particles.

### Example 3

### Synthesis of a Cathode and/or a Battery Using a Polymer-Coated, Shaped Sulfur-Nanocomposite

The cathodes and/or batteries described in this Example 3 were used in Examples 4-6 herein.

The cathodes were prepared by mixing the nanocomposite of Example 1 (60 wt. %), Super P carbon (20 wt. %), and poly(vinylidene fluoride) (PVdF) binder (20 wt. %), and dispersing the mixture in N-methylpyrrolidone (NMP) overnight to prepare a slurry. The slurry was then coated onto an aluminum foil, followed by evaporating the NMP at 50° C. under a flowing air oven for 24 h. The electrodes had a thickness of ˜30 μm and a sulfur content of 38-54 wt. %. The electrode was cut into circular disks of 0.64 cm² area. Electrochemical performances of the cells were evaluated with CR2032 coin cells between 1.5 and 2.8 V. The coin cells were assembled with electrodes using the nanocomposite of Example 1, a lithium foil anode, 1 M lithium trifluoromethanesulfonate in dimethoxy ethane (DME) and 1,3-dioxolane (DOL) (1:1 v/v) electrolyte, and a Celgard polypropylene separator.

### Example 4

### Cyclic Voltammetry of a Cathode Using a Polymer-Coated, Shaped Sulfur-Nanocomposite

Electrochemical performances of the cells were evaluated with CR2032 coin cells between 1.5 and 2.8 V. Cyclic voltammetry data were collected for cells of Example 3 between 1.5 and 2.8 V at a scanning rate of 0.2 mV s⁻¹ and at a rate of C/5.

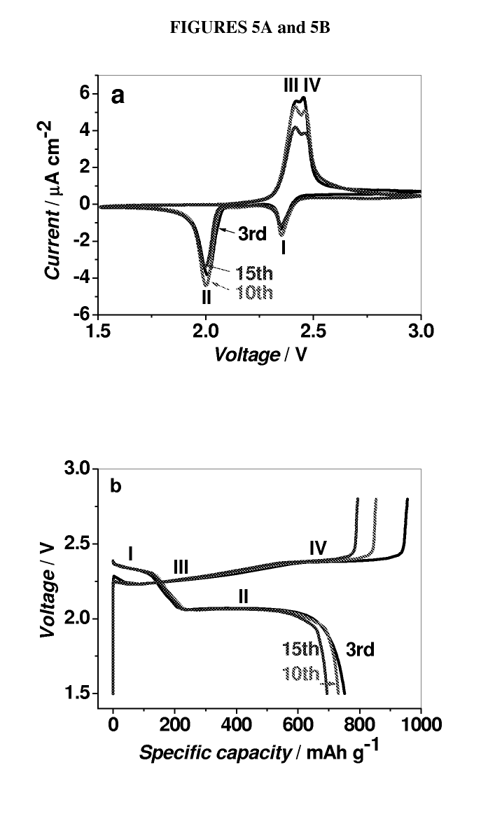

FIG. 5A provides CV data representing the 3^{rd}, 10^{th}, and 15^{th} cycles of the cathodes of Example 3 vs. lithium metal anode in a CR203 coin cell. The two separated reduction peaks at 2.4 (peak I) and 2.0 V (peak II) correspond to the conversion of, respectively, sulfur to lithium polysulfides and the polysulfides to Li₂S₂/Li₂S. The two overlapping oxidation peaks at 2.35 (peak III) and 2.45 V (peak IV) are associated with the conversion of, respectively, Li₂S₂/Li₂S to high-order polysulfides and those polysulfides to elemental sulfur. The two oxidation peaks are overlapping, implying continuous transitions of these compounds during the charging stage. In addition, while the oxidation peaks decrease as the cycling increases, the two reduction peaks are relatively stable, indicating good electrochemical stability of the nanocomposite as the conductive polypyrrole nanolayer on sulfur particles effectively suppresses the loss of sulfur and reduces the shuttling phenomenon during the charge/discharge processes.

FIG. 5B shows three representative charge/discharge voltage profiles vs. specific capacities of the nanocomposite cathode at C/5 rate. The four voltage plateaus which resemble the redox peaks in the cyclic voltammograms shown in FIG. 5A are indicated in the figure: two voltage plateaus (I and II) upon discharging and two voltage plateaus (III and IV) upon charging. The nanocomposite exhibits a relatively constant discharge capacity of >700 mAh g⁻¹ after 15 cycles, whereas the charge capacity decreases significantly with cycling. The voltage plateaus I and III remain constant after 15 cycles, indicating a reversible transition from sulfur to lithium polysulfides and Li₂S₂/Li₂S to lithium polysulfides. The voltage plateau II diminishes slightly after 15 cycles and the voltage plateau IV decreases significantly, indicating reduced shuttling phenomenon involving the conversion of lithium polysulfides to elemental sulfur with cycling.

### Example 5

### Coulombic Efficiency and Electrochemical Impedance Analysis of a Cathode Using a Polymer-Coated, Shaped Sulfur-Nanocomposite

Electrochemical impedance spectroscopy (EIS) data were collected with a computer interfaced HP 4192A LF Impedance Analyzer in the frequency range of 1M Hz-0.1 Hz with an applied voltage of 5 mV and Li foil as both counter and reference electrodes.

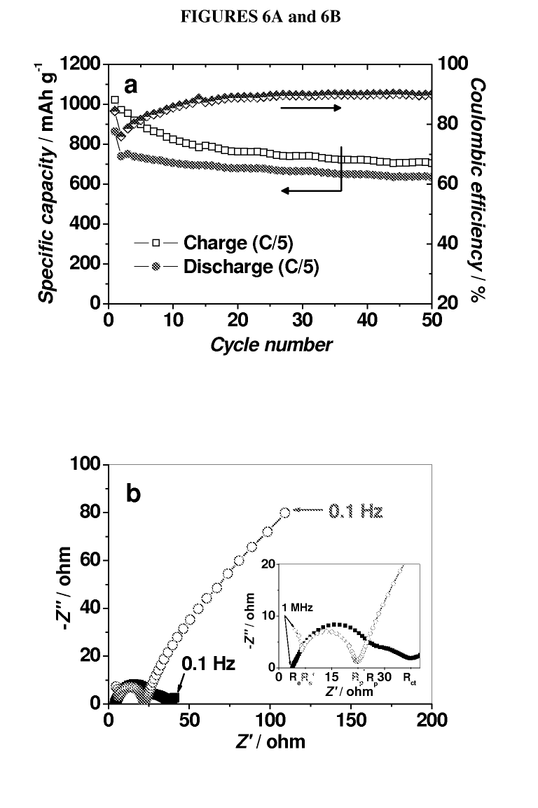

The nanocomposite cathode of Example 3 has been evaluated by extended cycling at C/5 rate as shown in FIG. 6A. The cathode exhibits a reduction in discharge capacity from 864 to 739 mAh g⁻¹ during the first two cycles. Afterwards, the cathode maintains a relatively constant capacity of >634 mAh g⁻¹ after 50 cycles, which is 100 mAh g⁻¹ higher than that of pure sulfur at the same rate. The charge capacity starting at 1,023 mAh g⁻¹ decreases steadily till it reaches a fairly stable value of 634 mAh g⁻¹. The Coulombic efficiency readily increases from 76 to 90% after the first drop from 84% in the 1^{st} cycle and remains constant for the rest of the cycles. At the beginning of the cycle, some lithium polysulfides formed could dissolve into the liquid electrolyte resulting in a loss of capacity. Afterwards, the polypyrrole nanolayer could become a stable interface between liquid electrolyte and sulfur, allowing lithium ions to pass-through and charge transfer with a minimum loss of active material. This process is evidenced by the electrochemical impedance analysis shown in FIG. 6B. Two semi-circles are present at high and medium frequency ranges before the extended cycling (black). The first semicircle (at high-frequency region) is ascribed to lithium-ion diffusion through the surface polypyrrole nanolayer, the second semicircle (at medium-to-low frequency region) is assigned to charge-transfer between the polypyrrole nanolayer and sulfur. According to the intercepts of the semi-cycles and the real axis, the resistances of the electrolyte (Rₑ=4.1 ohm), polypyrrole nanolayer (Rₚ=24.8 ohm), and charge transfer (R_{ct}=10.2 ohm) can be obtained, as shown in the inset in FIG. 6B. After the extended 50 cycles, the resistance of the electrolyte (Rₑ′=5.1 ohm) is slightly increased due to the dissolved lithium polysulfides retarding lithium ion transport and the resistance of the polypyrrole nanolayer (Rₚ′=16.9 ohm) is significantly decreased showing its improved conducting property. In contrast, the resistance of the charge transfer vanished, indicating improved electrochemical contact between sulfur and the polypyrrole nanolayer during extended cycling. A slope at the low-frequency region corresponding to Warburg impedance is observed, which is attributed to lithium-ion diffusion in the bulk sulfur particles.

### Example 6

### Rate Capabilities of a Cathode Using a Polymer-Coated, Shaped Sulfur-Nanocomposite

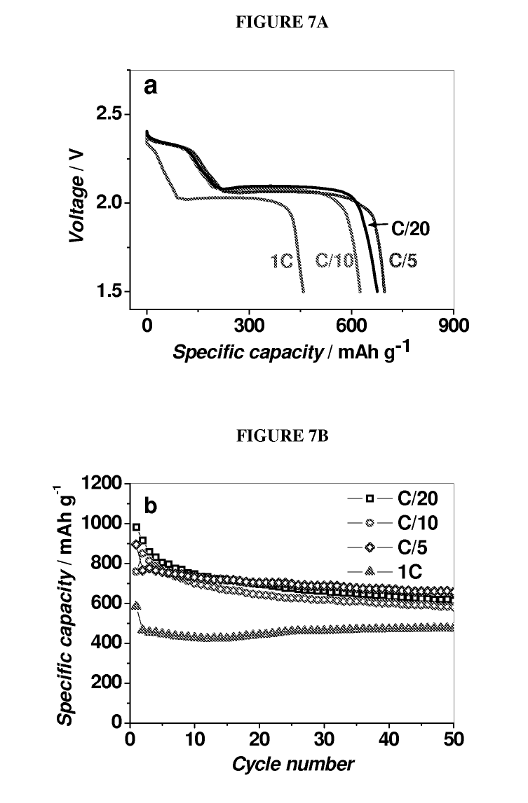

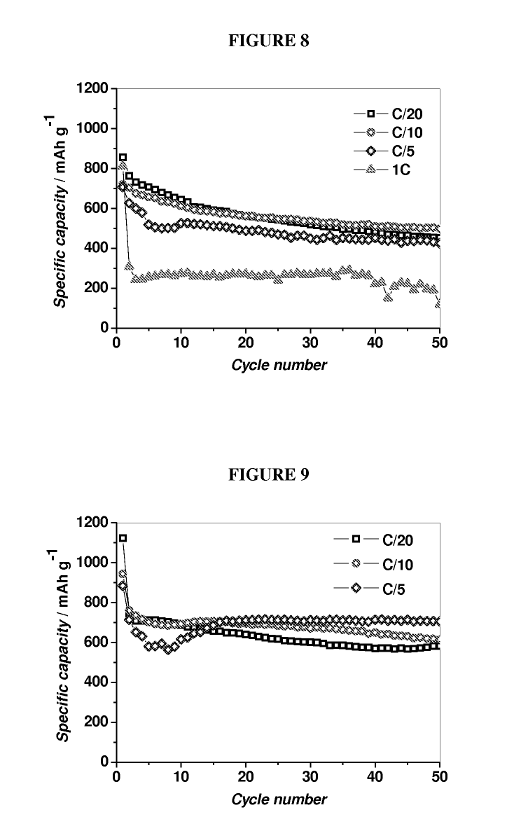

The rate capability of the nanocomposite electrode of Example 3 was also evaluated, as shown in FIGS. 7A and 7B. Representative (25^{th} cycle) voltage profiles vs. specific capacity of sulfur are presented in FIG. 7A. Almost identical discharge capacities were obtained at C/20, C/10, and C/5, and a capacity reduction in the voltage plateau I at 1C rate was observed, suggesting a sluggish transition of elemental sulfur to lithium polysulfides at high rate. FIG. 7B shows the extended cycle life at various rates. The nanocomposite exhibits a capacity loss during the 1^{st} cycle for all the rates tested. The discharge capacities (>600 mAh g⁻¹) are very close for C/20, C/10, and C/5 rates over 50 cycles, and the discharge capacity at 1C is between 400-500 mAh g⁻¹, which is also much higher than that (<300 mAh g⁻¹) of pure sulfur, as shown in FIG. 8. The cycling stability of the materials is evidenced by the good capacity retention at rates of C/5 and 1C after the 1^{st} cycles. For a cathode using a polymer-coated, shaped sulfur-nanocomposite with higher sulfur content (90 wt. %), similar cycling stability was obtained as shown in FIG. 9. The cycling stability of the materials can be attributed to the protection of the sulfur particles by the conductive polypyrrole nanolayer, which can facilitate electron transport between carbon and sulfur, allow access of liquid electrolyte to the inner sulfur particles, and minimize loss of sulfur during cycling. Moreover, the improved polypyrrole interface and electrochemical contact between sulfur and the polypyrrole nanolayer during cycling can significantly improve the cycling stability and maintain high capacities and Coulombic efficiency.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount.

1. A nanocomposite comprising:
shaped sulfur;
a polymer layer coating the shaped sulfur.

2. The nanocomposite of claim 1, wherein the shaped sulfur is a bipyramidal shape.

3. The nanocomposite of claim 1, wherein the polymer layer is generally uniform.

4. The nanocomposite of claim 3, wherein the polymer layer is generally uniform in thickness.

5. The nanocomposite of claim 4, wherein the polymer layer is about 100 nm thick.

6. The nanocomposite of claim 3, wherein the polymer layer is generally uniform in content.

7. The nanocomposite of claim 1, wherein the polymer is generally uniform in shape.

8. The nanocomposite of claim 1, wherein the polymer layer comprises nanospheres.

9. The nanocomposite of claim 1, wherein the polymer layer comprises at least one of polypyrrole, polyaniline, polythiophene, their derivatives, or combinations thereof.

10. The nanocomposite of claim 1, wherein the shaped sulfur comprises between about 50 and 90% by weight of the nanocomposite.

11. The nanocomposite of claim 1, wherein the polymer coating is electrically conductive.

12. The nanocomposite of claim 1, wherein the polymer coating inhibits dissolution of polysulfides away from the nanocomposite.

13. A method of synthesizing a nanocomposite comprising:
forming a shaped sulfur, comprising
preparing an aqueous solution of a sulfur-based ion and a micelle-forming agent, and
adding a nucleating agent, wherein the nucleating agent is configured to cause sulfur from the sulfur-based ions to nucleate into shaped sulfur particles within micelles formed by the micelle-forming agent; and
coating the shaped sulfur with a polymer layer.

14. The method according to claim 13, wherein the sulfur-based ion is prepared in the aqueous solution through the dissolution of metal thiosulfate.

15. The method according to claim 13, wherein the micelle-forming agent comprises a compound with a hydrophilic head and a hydrophobic tail.

16. The method according to claim 15, wherein the micelle-forming agent comprises decyltrimethylammonium bromide (DeTAB).

17. The method according to claim 13, wherein the micelles are dynamic and change their shape to facilitate the shaped sulfur forming into orthorhombic crystals.

18. The method according to claim 13, wherein the nucleating agent provides hydrogen ions (H⁺) to the sulfur-based ion.

19. The method according to claim 18, wherein the nucleating agent comprises hydrochloric acid.

20. The method according to claim 13, wherein the coating step further comprises adding monomers of the polymer to the aqueous solution.

21. The method according to claim 13, wherein the monomers comprise precursors for at least one of polypyrrole, polyaniline, polythiophene, their derivatives, or combinations thereof.

22. The method according to claim 13, wherein the coating step further comprises monomers aggregating into nanospheres within micelles.

23. The method according to claim 22, wherein the monomers forming into nanospheres is facilitated by a polymerizing reagent.

24. The method according to claim 22, wherein the monomers self-assemble into nanospheres.

25. The method according to claim 22, wherein the coating step further comprises the nanospheres binding to the shaped sulfur.

26. The method according to claim 25, wherein the binding is chemical bonds.

27. The method according to claim 25, wherein the binding is a physical bond.

28. The method according to claim 27, wherein the physical bond is by Van der Waal's forces.

29. The method according to claim 13, wherein the method is performed between about 0 and 120° C.

30. The method according to claim 13, wherein the forming step is performed at room temperature.

31. The method according to claim 13, wherein the coating step is performed between about 0 and 5° C.

32. A cathode comprising:
a nanocomposite comprising
shaped sulfur;
a polymer layer coating the shaped sulfur.

33. A battery comprising:
a cathode comprising:
a nanocomposite comprising
shaped sulfur;
a polymer layer coating the shaped sulfur;
an anode; and
an electrolyte.

34. The battery of claim 33, wherein the battery has a capacity of greater than 600 mAh/g after 50 cycles at a C/5 rate.
